(19) United States
(12) Patent Application Publication
(10) Pub. No.: US 2011/0120207 A1
(43) Pub. Date: May 26, 2011

(54) METHOD AND DEVICE FOR CHARACTERIZING MAGNETORHEOLOGICAL FLUIDS

(75) Inventors: Claus Gabriel, Griesheim (DE); Peter Schuler, Ludwigshafen (DE); Christoffer Kieburg, Maxdorf (DE); Günter Oetter, Frankenthal (DE); Martin Laun, Mannheim (DE)

(73) Assignee: BASF SE, Ludwigshafen (DE)

(21) Appl. No.: 12/953,634

(22) Filed: Nov. 24, 2010

(30) Foreign Application Priority Data
Nov. 24, 2009 (EP) 09176882.0

(51) Int. Cl. G01F 1/58; G01F 1/56; G01F 25/00

(52) U.S. Cl. 73/1.16; 73/861.08; 73/861.11

(57) ABSTRACT

A method for characterizing magnetorheological fluids using a volume flow rate measurement. The volume flow of the magnetorheological fluid through a capillary is initially measured, with a constant weight force being applied onto the magnetorheological fluid. A magnetic field is then applied to the capillary, and the volume flow of the magnetorheological fluid through the capillary is measured with the magnetic field applied, with a second constant weight force being applied onto the magnetorheological fluid. A device for carrying out the method comprises a container for storing a magnetorheological fluid, wherein the container is connected on one side to a capillary through which the magnetorheological fluid can flow, and is closed on a different side by a movable piston, which presses the magnetorheological fluid through the capillary with a constant weight force, and means for generating a magnetic field are provided in the region of the capillary.

The invention relates to a method for characterizing magnetorheological fluids by a volume flow rate measurement. The invention furthermore relates to a device for carrying out the method.

Magnetorheological fluids (abbreviation: MRF) refers to liquids which change their rheological properties under the effect of a magnetic field. They are usually suspensions of ferromagnetic, superparamagnetic or paramagnetic particles in a carrier liquid. The carrier liquid is also often referred to as a base oil. If such a suspension is exposed to a magnetic field, then its flow resistance increases. This is due to the fact that the dispersed magnetizable particles, for example iron powder, form chain-like structures parallel to the magnetic field lines because of their magnetic interaction. These structures are partially destroyed during the deformation of a magnetorheological fluid, but they reform. The rheological properties of a magnetorheological fluid in a magnetic field resemble the properties of a plastic body with a yield point, i.e. at least a minimum shear stress must be applied in order to make the magnetorheological fluid flow.

Magnetorheological fluids belong to the group of non-Newtonian fluids. The viscosity depends greatly on the imposed shear rate. The reversible viscosity change by imposing a magnetic field can take place within milliseconds.

The rheological behavior of a magnetorheological fluid can be described approximately by a Bingham model, the yield point of which rises with an increasing magnetic field strength. For example, shear stress values of a few 10,000 N/m² can be achieved with magnetic flux densities of less than one tesla. High transmissible shear stresses are required for the use of magnetorheological fluids in devices such as shock absorbers, clutches, brakes and other controllable equipment, for example haptic devices, crash absorbers, steer-by-wire guiding systems, gear-and-brake-by-wire systems, holding systems, prostheses, fitness equipment or bearings.

Since even minor differences in the concentration of the magnetizable particles can cause great changes in the flow rate, for example when using carbonyl-iron powder even a 0.1% by weight difference in the concentration of carbonyl-iron powder particles can cause significant changes in the flow behavior, characterization of the magnetorheological fluid requires a measurement method which detects even such minor differences. A density determination of the magnetorheological fluid, for example, is not sensitive enough in order to detect such variations.

The most important properties of magnetorheological fluids to be controlled are the flow behavior without an applied magnetic field and the flow behavior with an applied magnetic field. These properties depend on the composition of the magnetorheological fluid, that is to say the magnetizable particle content in the carrier liquid. Furthermore, these properties also depend on the type and amount of additives used.

Owing to the significant changes in the flow behavior with minor even differences in the composition, production control as well as product reception control is required for magnetorheological fluids, for which a robust, easily operable and reproducible measurement method ought to be used. At present, however, no special or even commercially available method for the production control of magnetorheological fluids is known.

A method for determining the flow behavior of a magnetorheological fluid is described, for example, in C. Gabriel, H. M. Laun, Combined slit and plate-plate magnetorheometry of a magnetorheological fluid (MRF) and parameterization using the Casson model, Rheol. Acta (2009) 48, pages 755 to 768. Here, the volume flow through a capillary is adjusted. This method, however, can be carried out only in the laboratory and requires elaborate adjustment of the movement of the driven piston. This method is therefore scarcely feasible for product reception control.

Although commercial magnetorheometers which are conventionally used to study the flow behavior of liquids are available, they nevertheless have significant disadvantages in respect of the production control of magnetorheological fluids. For instance, they are generally very sensitive apparatus which can be operated only by trained personnel. Furthermore, the measurement results depend strongly on accurate dosing of the magnetorheological fluid. Furthermore, without suitable homogenization of the samples of the magnetorheological fluid, statistically relevant information cannot be obtained since the sample quantities to be dosed in known magnetorheometers lie in the range of a few 100 μl.

In order to study the flow behavior of other non-Newtonian fluids, for example polymer melts, melt index testing is used for production and reception control of the specified fluid properties. The corresponding test equipment for carrying out a melt index test, however, cannot be used for testing a magnetorheological fluid since it is not possible to study the flow behavior with an applied magnetic field and without a magnetic field.

It is therefore an object of the present invention to provide a method and a device which allow production control of magnetorheological fluids, which are robust and easy to operate and which deliver reproducible measurement results.

The object is achieved by a method for characterizing magnetorheological fluids by a volume flow rate measurement, comprising the following steps:
(a) measuring the volume flow of the magnetorheological fluid through a capillary, a constant weight force being applied onto the magnetorheological fluid,
(b) applying a magnetic field to the capillary,
(c) measuring the volume flow of the magnetorheological fluid through the capillary with the magnetic field applied, a second constant weight force being applied onto the magnetorheological fluid.

Measuring the volume flow of the magnetorheological fluid through a capillary, a constant weight force being applied onto the magnetorheological fluid, makes the measurement method reproducible. In contrast to measurements with known commercial magnetorheometers, the method can even be carried out by untrained personnel.

In order to be able to apply a constant weight force onto the magnetorheological fluid, it is preferable for the magnetorheological fluid to be stored in a container and pressed out of the container into the capillary. To this end, it is particularly preferable for the capillary to be connected directly to the container.

In a preferred embodiment, the constant weight force which is applied onto the magnetorheological fluid in step (a), and the second constant weight force which is applied onto the magnetorheological fluid in step (c), are of equal size. It is, however, possible to apply different weight forces in steps (a) and (c).

The constant weight force is preferably applied onto the magnetorheological fluid by the weight force of a piston which closes the container. Applying the force by the weight force of a piston which closes the container allows a reproducible uniform force to be applied onto the magnetorheological fluid. Furthermore, the volume flow must also be measured without at the same time having to exert an additional force onto the piston.

In order to obtain reproducible results in an applied magnetic field as well, it is advantageous to carry out the measurement in an applied magnetic field with a greater mass and therefore greater weight force of the piston, for example by applying additional weights onto the piston. As an alternative, different pistons respectively with a different mass may be used for measuring with an applied magnetic field and without an applied magnetic field. When a modified weight force is intended to be applied, the use of a piston with a constant mass and the application of additional weights are preferred.

The measurement of the volume flow may for example be carried out by collecting the magnetorheological fluid which flows through the capillary over a predetermined period of time, and measuring the amount of magnetorheological fluid collected. The ratio of the amount of magnetorheological fluid collected to the measurement time gives the volume flow rate. As an alternative, it is also possible to track the position of the piston and calculate from the piston's position the amount of magnetorheological fluid which has flowed through the capillary. The volume flow is initially measured without an applied magnetic field. After a measurement has been carried out without an applied magnetic field, a measurement is carried out with an applied magnetic field. In order to obtain reproducible measurements, it is necessary for the magnetic fields to be of equal size in each measurement. In order to ensure that the strength of the magnetic field does not change, it is advantageous for the strength of the applied magnetic field to be checked after a predetermined number of measurement cycles. If the test of the strength of the applied magnetic field reveals that the strength of the magnetic field differs by a maximum predetermined value from the value specified for the measurement, it will for example be necessary to replace the magnets being used, in particular when using permanent magnets. When using an electromagnet, it may for example be necessary to change the yoke or the coil. As an alternative, in this case it is also possible to adapt the strength of the magnetic field by changing the applied voltage or the applied current. The maximum permissible deviation is preferably 0.5% of the magnetic field's flux density specified for the measurement.

In order to check the strength of the applied magnetic field, for example when using permanent magnets, a frame may be constructed in which the magnets are held at the same separation as when the capillary is used. The space between the magnets contains a sleeve to contain a Hall probe. When using electromagnets, a corresponding structure may be used for checking them.

In order to be able to characterize the magnetorheological fluid with the aid of the volume flow rate measurement, it is furthermore advantageous initially to compile a calibration curve. In order to compile the calibration curve, magnetorheological fluids with a known composition may be measured first. By comparing the measured volume flow of any magnetorheological fluid with the calibration curve, the composition may then be deduced from the volume flow.

In order to carry out the method, it is preferable to use a device which comprises a container for storing a magnetorheological fluid to be studied, the container being connected on one side to a capillary through which the magnetorheological fluid can flow. On a side different to the side with the capillary, the container is closed by a movable piston in order to press the magnetorheological fluid through the capillary with a constant weight force. In the region of the capillary, means are provided for generating a magnetic field.

So that the magnetorheological fluid can flow through the capillary, the minimum diameter of the capillary for a capillary with a round cross section, or the minimum height for a capillary with a polygonal cross section, is at least 10 times as great, preferably at least 50 times as great, as the average diameter of the magnetizable particles. The term height refers to the distance from the base of the cross-sectional area to the opposite side or an opposite vertex. This dimensioning will ensure that the capillary cannot be clogged by particles.

If a capillary with a round cross section is used, then the diameter of the capillary preferably lies in the range of from 0.05 to 5 mm, more preferably in the range of from 0.3 to 2 mm, and particularly in the range of from 0.5 to 1.2 mm.

The length of the capillary will be selected so that it is long enough for a magnetic field to be applied. The ratio of the length to the radius of the capillary lies for example in the range of from 2 to 60, preferably in the range of from 4 to 20, and particularly in the range of from 6 to 12.

Besides the use of a capillary with a round cross section, it is however also possible to use a capillary with any other desired cross section. For instance, the cross section of the capillary may be configured in the form of a polygon, for example a triangle, a square or a rectangle. Besides capillaries with a round cross section, so-called slit capillaries are also suitable which usually have a rectangular cross section or an elliptical cross section, the ratio of the long side to the short side of the rectangle or the major axis to the minor axis of the ellipse lying at least in the range of from 1 to 20.

It is however preferable to use the capillary with a round cross section, since this will be easier to clean in comparison with a slit capillary. The advantage of a slit capillary, on the other hand, is that the magnetic field can be arranged perpendicularly to the shear plane so that there are ideal rheometric conditions for studying the magnetorheological fluid.

As an alternative to using a capillary with a constant cross section, it is also possible to use a capillary in which the cross section changes conically. In this case, the cross section of the capillary may increase or decrease in the flow direction. It is, however, preferable to use a capillary with a constant cross section.

Any desired nonmagnetic or non-magnetizable material, from which a capillary can be made, may be used as a material for the capillary. Preferred materials from which the capillary may be made are plastics, ceramics, nonmagnetic steel, brass, copper, aluminum or titanium.

The capillary, through which the magnetorheological fluid flows during the measurement, may be fastened directly on the container. As an alternative, it is also possible to provide an adapter, in which case the adapter will be connected on one side to the container and on the other side to the capillary. The adapter used may for example have a constant cross section, the cross section of the adapter being greater than the cross section of the capillary and less than the cross section of the container. This forms a stepped transition from the container into the adapter and from the adapter into the capillary. As an alternative, it is also possible for the cross section of the adapter to decrease from the container to the capillary. The decrease in the cross section may, for example, take place in steps. As an alternative, it is also possible for the cross section of the adapter to decrease conically, parabolically or hyperbolically. It is also possible to use an adapter which has a cross section that initially remains constant and then decreases conically, parabolically or hyperbolically. The cross section at the entry into the adapter, that is to say on the side on which the adapter is connected to the container, may also initially decrease conically, parabolically or hyperbolically, then remain constant and again decrease conically, parabolically or hyperbolically at the transition into the capillary. The advantage of a conical, parabolic or hyperbolic decrease in the cross section is that uniform flow of the magnetorheological fluid is achieved out of the container into the adapter and from the adapter into the capillary.

The adapter is preferably made of the same material as the capillary. It is, however, also possible to make the adapter and the capillary from different materials.

The container is preferably configured with a size such that the amount of magnetorheological fluid stored in the container is sufficient to ensure a reproducible measurement. The container preferably has a round cross section, and has a diameter for example in the range from 3 to 30 mm, preferably in the range of from 5 to 15 mm, and particularly in the range of from 8 to 12 mm. Besides a round cross section, the container may however also have any other desired cross section, for example a polygonal cross section, for example a triangular, rectangular, square or hexagonal cross section. The height of the reservoir is preferably from 50 to 100 mm. In this way, it is possible to store a sufficiently large amount of magnetorheological fluid in order to achieve a reproducible measurement.

The container is preferably likewise made of the same material as the capillary and, if an adapter is used, as the adapter. Plastics, ceramics, nonmagnetic steel, brass, copper, aluminum or titanium are likewise suitable as a material for the container.

In order to be able to measure the volume flow through the capillary without a magnetic field and with an applied magnetic field, a magnet is arranged in the region of the capillary. Both permanent magnets and electromagnets are suitable as the magnet. The magnet used preferably has a flux density of up to 1.5 tesla, preferably up to 1 tesla.

If a permanent magnet is employed, then it is preferable to use a permanent magnet made of a hard magnetic material. Suitable magnets, for example, are magnets made of iron-carbon alloys with a martensitic lattice structure, which optionally contain chromium, cobalt or vanadium as alloy additives. Furthermore, AlNiCo alloys are also suitable, for example 10Al-20Ni-20Co-50Fe. Also suitable are rare earth-cobalt magnets, for example SmCo₅, hard magnetic ferrites such as barium ferrite, for example BaO.6Fe₂O₃ or strontium ferrite (SrO.6Fe₂O₃). Neodymium-iron-boron with the composition Md₂Fe₁₄B is furthermore suitable. This can be used up to temperatures of 80° C. Further rare earth elements may be added in order to increase the thermal stability.

Neodymium-iron-boron is particularly preferred as a material for the magnet.

Besides permanent magnets, it is also possible to use electromagnets as the magnets. If the magnet is an electromagnet, then an electromagnet having a coil and a magnet yoke will be used in particular. The magnet yoke in this case has a gap in which the capillary is positioned.

In a first embodiment, the size of the magnet is selected so that, with an applied magnetic field, the entire capillary is permeated by the magnetic field. This means that the effective length of the capillary is the same with an applied magnetic field and without an applied magnetic field.

As an alternative, it is also possible for the capillary to have an inlet and an outlet which are not permeated by the magnetic field. In this case, the effective length of the capillary is greater without an applied magnetic field than with an applied magnetic field.

An equal effective length with an applied magnetic field and without an applied magnetic field may also be achieved, for example, by the capillary having a larger diameter in the inlet and in the outlet, that is to say in the regions which are not permeated by the magnetic field. This may, for example, be achieved by boring out the capillary.

The movable piston, by which the container is closed on one side and with the aid of which the magnetorheological fluid is pressed from the container into the capillary, may be located on any desired side of the container. It is, however, preferable for the movable piston to be arranged on the upper side of the container and to be movable merely by the force of gravity.

Uniform flow through the capillary is achieved, in particular, by arranging the capillary on the opposite side of the container from the piston. With a piston arranged on the upper side of the container, this means that the flow takes place from the top downward in the direction of the force of gravity.

In order to prevent some of the magnetorheological fluid from being pressed out of the container through a gap between the piston and the container, it is furthermore preferable for the movable piston to be guided in the container by a sealing element. In this case, the sealing element seals the interior of the container, which is filled with the magnetorheological fluid, from the surroundings. Any desired sealing element known to the person skilled in the art, which is suitable for delimiting the interior of the container from the surroundings in the region of the movable piston, may be used as a sealing element. To this end, the sealing element is usually fastened on the piston, for example by the sealing element being accommodated in a groove of the piston.

For example round sealing rings such as O-rings or quad-rings, X-rings or W-rings, which are respectively accommodated in a groove in the piston, are suitable as sealing elements. A sealing tape placed around the piston is also suitable. Furthermore, it is also possible to use a cylindrical seal which, for example, is also positioned in a groove in the piston. Furthermore, it is also possible for an appendage made of a sealing material to be fitted onto the piston. In this case, the piston will be guided in the container by the appendage.

In order not to block the movement of the piston in the container, the sealing element is preferably made of a material which has a low sliding friction in relation to the material of the container. If a sealing element is not used, then it is particularly preferable for the piston to have a surface which has a low sliding friction in relation to the material of the container. In this way, it is also possible for the piston to have a surface which is also suitable for sealing the container from the surroundings. So that the piston has a surface which has a low sliding friction in relation to the material of the container, it is for example possible to provide the piston with a surface coating made of a material which has a low sliding friction in relation to the material of the container. As an alternative, it is also possible to make the entire piston from a material with a low sliding friction in relation to the material of the container.

For example, polytetrafluoroethylene (PTFE) is suitable as a material for the sealing element by which the movable piston is guided in the container, or from which the surface of the piston is made.

Besides fastening the sealing element on the piston, as an alternative it is also possible to fasten the sealing element in a groove in the container and to guide the piston along this sealing element. In this case, the piston must be made long enough for there to be constant contact with the sealing element.

For example, polytetrafluoroethylene (PTFE), natural rubber (NR), nitrile rubber (NBR), styrene-butadiene rubber (SBR), Viton, Kalrez, polyurethane (PU) or ethylene-propylene terpolymers (EPDM) are suitable as a material for the sealing element.

In order to ensure unimpeded operation of the device, the sealing element will be dimensioned so that the friction force of the seal is very much less than the weight force of the piston. It is preferable for the friction force to correspond at most to 0.5 times the weight force of the piston. It is more preferable for the friction force to correspond at most to 0.25 times the weight force and, in particular, for the friction force to correspond at most to 0.1 times the weight force of the piston. Here, the term weight force of the piston is intended to mean the weight force of the piston with optionally applied additional weights. In order to obtain reproducible measurements, it is advantageous to carry out regular inspection of the sealing elements and to provide regular replacement of the sealing elements.

The method according to the invention is suitable for any magnetorheological fluids. These are generally suspensions of ferromagnetic, superparamagnetic or paramagnetic particles in a carrier liquid. For example, carbonyl-iron powder is used as ferromagnetic particles which are suspended in the carrier liquid, also referred to as the base oil. Conventionally used carrier liquids are for example mineral oils, silicone oils, water and ionic liquids. The proportion of ferromagnetic, superparamagnetic or paramagnetic particles in the magnetorheological fluid generally lies in the range of from 1 to 70% by volume.

An exemplary embodiment of the invention is represented in the figures and will be explained in more detail in the following description.

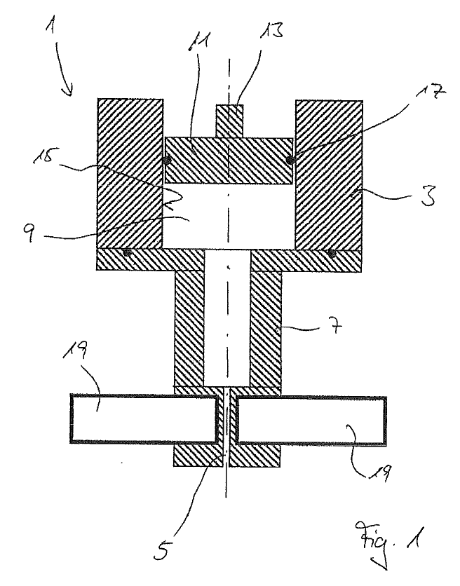

FIG. 1 shows a sectional representation of a device according to the invention,

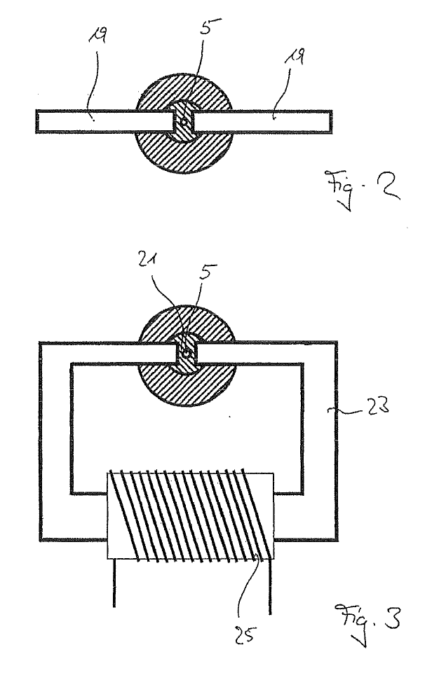

FIG. 2 shows a plan view of a device according to the invention in the region of the capillary when using permanent magnets,

FIG. 3 shows a plan view of a device according to the invention in the region of the capillary when using an electromagnet.

FIG. 1 represents a device according to the invention in section.

A device 1 for characterizing magnetorheological fluids by a volume flow rate measurement comprises a container 3, which is connected to a capillary 5. In the embodiment represented here, the capillary 5 is fastened on the container 3 by using an adapter 7.

In the container 3, a space 9 is formed in which a magnetorheological fluid to be studied is stored. The magnetorheological fluid is pressed out of the space 9 through the adapter 7 and into the capillary 5, so that it flows through the capillary. In order to be able to press the magnetorheological fluid into the capillary 5, the space 9 in the container 3 is closed on one side by a piston 11. The piston 11 is mounted movably, and can be inserted into the space 9 so that the volume of the space 9 is reduced. According to the invention, the piston 11 is moved merely owing to its own weight force, and optionally that of additional weights which are applied onto the piston. This makes it possible to carry out reproducible measurements, since the force acting on the magnetorheological fluid in the space 9 is always the same.

The piston 11 is made so that it has a sufficiently large mass to deliver reproducible results. The dimensions of the piston will depend on the material used and therefore the density of the material used, from which the piston 11 is made. When studies in which different pressure forces act on the magnetorheological fluid in the space 9 are intended to be carried out on the magnetorheological fluid, it is for example respectively possible to replace the piston and use pistons with a different mass. As an alternative and preferably, it is for example also possible to apply additional weights onto the piston 11. To this end, for example when the piston is configured as represented in FIG. 1, it is possible to place rings with particular predetermined masses around a central piston rod 13. The use of rings has the advantage that the weights formed by the rings cannot slip.

In a preferred embodiment, the space 9, the piston 11, the adapter 7 and the capillary 5 are formed axisymmetrically, preferably with a circular cross section. Besides a circular cross section, the space 9, the adapter 7 and the capillary 5 may also have any other desired cross section, for example a polygonal cross section with three or more vertices. It is, however, preferable for the cross section to be circular.

As an alternative to the embodiment represented here with an adapter 7, it is also possible to connect the capillary 5 directly to the space 9 of the container 3 and to obviate the adapter 7.

If an adapter 7 is used, then as represented here it may have a constant cross section over its length. It is, however, also possible for the adapter 7 to be configured for example with a conically, parabolically or hyperbolically reducing cross section. The cross section in this case decreases from the space 9 to the capillary 5. Furthermore, it is also possible to form the adapter 7 with cross-sectional narrowings and sections with a constant cross section. For example, it is possible to form a conical, parabolic or hyperbolic intake from the space 9 of the container 3 into the adapter 7 and a likewise conical, parabolic or hyperbolic output from the adapter 7 into the capillary 5, and to configure the section between the intake and the output with a constant cross section. Furthermore, it is also possible for example to provide a conical intake and a parabolic or hyperbolic output. Any other desired configuration is also possible. Furthermore, it is also possible to configure the adapter 7 for example with a cross-sectional area decreasing in steps. In this case, for example, it is possible for the decrease in the cross-sectional area respectively to take place with right-angled steps. As an alternative, however, it is also possible respectively to provide a conical, parabolic or hyperbolic cross-sectional decrease between the individual sections with a constant cross section.

In order to prevent the magnetorheological fluid from being able to emerge between the piston 11 and the walls 15 of the container 3, the piston 11 is guided in the container 3 by a sealing element 17. So that the piston 11 can press the magnetorheological fluid through the capillary 5 only by its own weight force, the mass of the piston 11 is selected so that the weight force is greater than the friction force of the sealing element 17. Furthermore, a material with a low friction coefficient in relation to the material of the walls 15 of the container 3 will preferably be selected as the material for the sealing element 17. In particular, polytetrafluoroethylene is suitable as the material.

As an alternative to a sealing element 17, as represented in FIG. 1, it is also possible to provide the piston 11 with a sealing material as its surface. It is also possible, for example, to form the entire piston from a sealing material. If the piston is provided with a sealing surface, then this will preferably be formed from polytetrafluoroethylene. Thus, for example, it is possible to fit a polytetrafluoroethylene cap onto the piston 11. The cap then acts at the same time as a sealing element 17 and, owing to its low friction in relation to the wall 15 of the container 3, ensures uniform movement of the piston 11.

In order to be able to measure the volume flow through the capillary 5 with an applied magnetic field, in the embodiment represented here bar magnets 19 are arranged in the region of the capillary 2. The bar magnets 19 are positioned so that one magnet points toward the capillary with its north pole and the other bar magnet with its south pole, so that the bar magnets lie opposite one another. The angle between the bar magnets is preferably 180°. Other angles between the bar magnets are however also possible, for example 90°. It is also possible to use only one bar magnet. In this way, a magnetic field is generated in the capillary 5. The bar magnets 19 are preferably fastened removably so that, besides a measurement with an applied magnetic field, a measurement can also be carried out without a magnetic field. To this end, the bar magnets 19 will merely be removed.

As an alternative to the use of bar magnets 19, it is also possible for example to use a horseshoe magnet. The magnet should, however, be configured in such a way that the north and south poles lie opposite in the region of a gap in which the capillary can be positioned, so that an essentially homogeneous magnetic field is generated in the capillary 5.

FIG. 2 represents in plan view a device according to the invention in the region of the capillary when using permanent magnets. In plan view, the bar magnets 19, which enclose the capillary 5 while respectively lying opposite one another, can be seen clearly. Any desired hard magnetic material is suitable as a material for the bar magnets 19 formed as a permanent magnet. Neodymium permanent magnets are particularly preferred, for example permanent magnets made of the alloy neodymium-iron, boron. In order to increase the thermal stability of the magnets, further rare earth elements may be added.

Besides neodymium permanent magnets, hard magnetic ferrites are also suitable, for example barium ferrite or strontium ferrite. Rare earth-cobalt magnets may also be used.

Besides employing permanent magnets, the use of an electromagnet is also possible. This is represented in the region of the capillary in FIG. 3. In order to be able to measure the volume flow of the magnetorheological fluid through the capillary with an applied magnetic field, the capillary is positioned in a gap 21 of a magnet yoke 23 of an electromagnet 25. The advantage of using an electromagnet 25 is that it can be switched on and off so that, for a measurement without an applied magnetic field, the magnet does not need to be removed but merely has to be switched off. Any desired electromagnet known to the person skilled in the art is in this case suitable as an electromagnet. Any material suitable for a magnet yoke of an electromagnet may be used as the material for the yoke. A ferromagnetic core, for example made of iron, is preferably used for the magnet yoke at 23.

### LIST OF REFERENCES

1 device
3 container
5 capillary
7 adapter
9 space
11 piston
13 central piston rod
15 wall
17 sealing element
19 bar magnet
21 gap
23 magnet yoke
25 electromagnet

1-13. (canceled)

14. A method for characterizing magnetorheological fluids by a volume flow rate measurement, comprising the following steps:
(a) measuring the volume flow of the magnetorheological fluid through a capillary, a first constant weight force being applied onto the magnetorheological fluid,
(b) applying a magnetic field to the capillary,
(c) measuring the volume flow of the magnetorheological fluid through the capillary with the magnetic field applied, a second constant weight force being applied onto the magnetorheological fluid.

15. The method as claimed in claim 14, wherein the first constant weight force and the second constant weight force are of equal size.

16. The method as claimed in claim 14, wherein the magnetorheological fluid is stored in a container and pressed out of the container into the capillary.

17. The method as claimed in claim 16, wherein the predetermined force is applied onto the magnetorheological fluid by the weight force of a piston which closes the container.

18. The method as claimed in claim 14, wherein the strength of the applied magnetic field is checked after a predetermined number of measurement cycles.

19. The method as claimed in claim 14, wherein in order to compile a calibration curve, magnetorheological fluids with a known composition are measured first.

20. A device for carrying out the method as claimed in claim 14, comprising:
a container for storing a magnetorheological fluid to be studied, wherein the container is connected on a first side to a capillary through which the magnetorheological fluid can flow, and is closed on a second side, different from the first side, by a movable piston in order to press the magnetorheological fluid through the capillary with a constant weight force; and
means for generating a magnetic field are provided in the region of the capillary.

21. The device as claimed in claim 20, wherein the means for generating a magnetic field comprise an electromagnet or at least one permanent magnet.

22. The device as claimed in claim 20, wherein the movable piston is arranged on the upper side of the container and is configured to be moved merely by the force of gravity.

23. The device as claimed in claim 20, wherein the capillary is arranged on the opposite side of the container from the piston.

24. The device as claimed in claim 20, wherein the movable piston is guided in the container by a sealing element.

25. The device as claimed in claim 20, wherein the piston has a surface which has a low sliding friction in relation to the material of the container.

26. The device as claimed in claim 20, wherein the piston has a surface which is suitable for sealing the container from the surroundings.
